(19) United States
(12) Patent Application Publication
(10) Pub. No.: US 2014/0241779 A1
(43) Pub. Date: Aug. 28, 2014

(54) Image Forming Apparatus

(71) Applicant: Yasunori Akatsuka, Mizuho-shi (JP)

(72) Inventor: Yasunori Akatsuka, Mizuho-shi (JP)

(73) Assignee: BROTHER KOGYO KABUSHIKI KAISHA, Nagoya-shi (JP)

(21) Appl. No.: 14/190,212

(22) Filed: Feb. 26, 2014

(30) Foreign Application Priority Data
Feb. 27, 2013 (JP) 2013-036555

(51) Int. Cl. G03G 15/00; B65H 5/06; B65H 5/26

(52) U.S. Cl. CPC G03G 15/6561; G03G 15/6579; G03G 15/6567; B65H 5/26; B65H 5/062
USPC 399/393; 271/3.19

(57) ABSTRACT

An image forming apparatus includes a feed tray, an image forming unit including a photosensitive member, a registration mechanism including a registration roller pair and configured such that, after a leading edge of the sheet fed from the feed tray reaches the registration roller pair, the registration roller pair rotates to convey the sheet toward the photosensitive member along a conveying path, a switchback mechanism for switching back, along a re-conveying path, the sheet having an image formed thereon by the image forming unit, and a re-conveying roller for conveying the switched-back sheet toward the registration roller pair via a conjunction between the re-conveying path and the conveying path. The registration roller pair includes a registration driving roller and a registration pinch roller driven by the registration driving roller. The re-conveying roller in contact with the registration driving roller is driven by the registration driving roller.

### CROSS REFERENCE TO RELATED APPLICATION

This application claims priority from Japanese Patent Application No. 2013-036555, filed on Feb. 27, 2013, the entire disclosure of which is incorporated herein by reference.

### BACKGROUND OF THE INVENTION

1. Field of the Invention

The present invention relates to an image forming apparatus having a duplex printing function.

2. Description of Related Art

A known image forming apparatus comprises a registration roller pair disposed along a conveying path, and a re-conveying roller pair disposed along a re-conveying path. Each of the registration roller pair and the re-conveying roller pair comprises a driving roller and a driven roller which convey a sheet.

### SUMMARY OF THE INVENTION

It may be beneficial for an image forming apparatus to include a reduced number of components such as driving rollers and driven rollers for registering and conveying a sheet.

According to an embodiment of the invention, an image forming apparatus comprises a feed tray configured to hold a sheet thereon, an image forming unit comprising a photosensitive member and configured to form an image on the sheet, a registration mechanism comprising a registration roller pair and configured such that, after a leading edge of the sheet fed from the feed tray reaches the registration roller pair, the registration roller pair rotates to convey the sheet toward the photosensitive member along a conveying path in a conveying direction, a switchback mechanism disposed downstream of the photosensitive member in the conveying direction and configured to switch back, along a re-conveying path, the sheet having the image formed thereon by the image forming unit, and a re-conveying roller configured to convey the sheet switched back by the switchback mechanism toward the registration roller pair via a junction where the re-conveying path meets the conveying path. The registration roller pair comprises a registration driving roller, and a registration pinch roller configured to be driven by the registration driving roller. The re-conveying roller is in contact with the registration driving roller and configured to be driven by the registration driving roller.

Other objects, features, and advantages will be apparent to persons of ordinary skill in the art from the following detailed description of the invention and the accompanying drawings.

### BRIEF DESCRIPTION OF THE DRAWINGS

For a more complete understanding of the invention, the needs satisfied thereby, and the features and technical advantages thereof, reference now is made to the following descriptions taken in connection with the accompanying drawings.

FIG. 1 is a cross-sectional view of a laser printer as an example of an image forming apparatus according to an embodiment of the invention.

FIG. 2 is a perspective view of a re-conveying tray.

FIG. 3 is a plan view of the re-conveying tray.

FIG. 4 is an enlarged view of a registration roller pair and a re-conveying roller as viewed in a front-rear direction.

FIG. 5 is an enlarged view of a registration roller pair and its surroundings according to another embodiment of the invention.

### DETAILED DESCRIPTION OF EMBODIMENTS

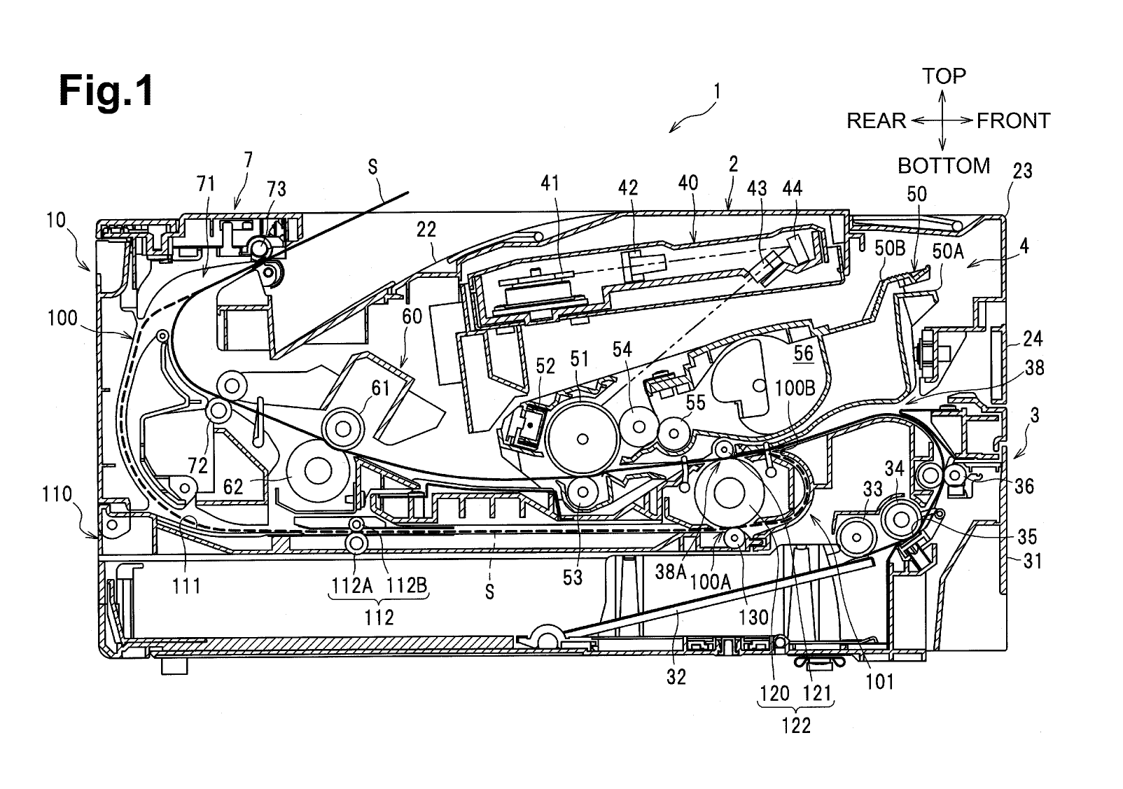

Embodiments of the invention and their features and technical advantages may be understood by referring to FIGS. 1-5, like numerals being used for like corresponding parts in the various drawings.

In the following description, the expressions “front”, “rear”, “top”, “bottom , “right”, and “left” are used to define the various parts when an image forming apparatus, e.g., a laser printer 1, is disposed in an orientation in which it is intended to be used.

<General Structure of Laser Printer>

As shown in FIG. 1, the laser printer 1 is configured to form images on both sides of a sheet S. A casing 2 of the laser printer 1 houses therein a feed unit 3, an image forming unit 4, a discharge unit 7, and a re-conveying unit 10.

The casing 2 comprises, at its front, a front cover 23 to be opened for attaching and removing a process cartridge 50 to be described later. The front cover 23 comprises a pivotable manual feed tray 24 for holding a manually inserted sheet S.

The feed unit 3 is disposed at the bottom in the casing 2 and configured to feed a sheet S to the image forming unit 4. The feed unit 3 comprises a feed tray 31, a sheet pressing plate 32, a feed roller 33, a separation roller 34, a separation pad 35, a convey roller 36, and a registration roller pair 122. The feed unit 3 partially defines a conveying path 38. The registration roller pair 122 comprises registration driving rollers 120 and a registration pinch roller 121, as will be described later.

A sheet fed from the feed tray 31 is conveyed along the conveying path 38 to the image forming unit 4, more specifically to a position between a photosensitive member, e.g., a photosensitive drum 51, and a transfer roller 53. The conveying path extends obliquely upward from a position near the feed roller 33, turns to direct itself rearward, and extends toward a position between the photosensitive drum 51 and the transfer roller 53.

The sheet pressing plate 32 presses sheets S accommodated in the feed tray 31 toward the feed roller 33. The feed roller 33 feeds the sheets from the feed tray 31. The separation roller 34 and the separation pad 35 separate one of the sheets from another. The convey roller 36 and the registration driving roller 120 convey a sheet along the conveying path 38 toward the photosensitive drum 51, more specifically, toward a position between the photosensitive drum 51 and the transfer roller 53.

The image forming unit 4 is disposed above the feed tray 31 and is configured to form an image on the fed sheet. The image forming unit 4 comprises an exposure unit 40, a process cartridge 50, and a fixing unit 60.

The exposure unit 40 is disposed at a top portion in the casing 2 and comprises a laser emitter (not shown), a polygon mirror 41 to be driven to rotate, lenses 42, 43, and a reflection mirror 44. Laser light (shown by a two-dot-one-dash line) emitted from the laser emitter based on image data is reflected by or passes through the polygon mirror 41, the lens 42, the reflection mirror 44, and the lens 44 sequentially and is scanned at high speed over a surface of the photosensitive drum 51.

The process cartridge 50 is disposed below the exposure unit 40 and is detachably attached to the casing 2 though an opening which is defined by the front cover 23 when opened. The process cartridge 50 comprises a photosensitive unit 50A and a developing unit 50B which is detachably attached to the photosensitive unit 50A.

The photosensitive unit 50A comprises a photosensitive drum 51, a charger 52, and a transfer roller 53. The developing unit 50B comprises a developing roller 54, a supply roller 55, and a toner chamber 56 for storing toner (developing agent).

The fixing unit 60 is disposed behind the process cartridge 50 and comprises a heat roller 61 and a pressure roller 62. The pressure roller 62 is disposed opposite to the heat roller 61 so as to press the heat roller 62.

In the image forming unit 4, the charger 52 uniformly charges the surface of the photosensitive drum 51, then the exposure unit 40 exposes the surface of the photosensitive drum 51 with laser light scanned at high speed, thereby forming an electrostatic latent image on the photosensitive drum 51. The supply roller 55 supplies toner from the toner chamber 56 to the developing roller 54, which carries the toner thereon.

When the toner carried by the developing roller 54 is supplied to the electrostatic latent image on the photosensitive drum 51, the electrostatic latent image is visualized as a toner image (developing agent image) on the photosensitive drum 51. The supply roller 55 supplies toner to the photosensitive drum 51 by way of the developing roller 54.

Subsequently, the photosensitive drum 51 and the transfer roller 53 convey therebetween the sheet S fed from the feed unit 31, thereby transferring the toner image on the photosensitive drum 51 onto the sheet S. The heat roller 61 and the pressure roller 62 convey therebetween the sheet S, thereby thermally fixing the toner image onto the sheet S.

The discharge unit 7 is configured to convey the sheet S having a toner image thermally fixed thereon out of the casing 2. The discharge unit 7 defines a discharge path 71 and comprises a convey roller 72 and a discharge roller 73.

The sheet S conveyed from the image forming unit 4 is guided in a curved manner along the discharge path 71 and out of the casing 2.

The discharge roller 73 is disposed near an outlet defined along the discharge path 71 and is configured to rotate in forward and reverse directions by a known method. More specifically, the discharge roller 73 discharges the sheet S out of the casing 2 when it rotates in the forward direction, and conveys the sheet S toward the re-conveying unit 10 when it rotates in the reverse direction.

In the discharge unit 7, as shown by a solid line, the convey roller 72 conveys the sheet S, which is conveyed from the image forming unit 4, obliquely rearward and upward and turns the sheet S forward toward the discharge roller 73. The discharge roller 73 rotating in the forward direction discharges the sheet S out of the casing 2 when printing on a single side of the sheet S is completed in a simplex mode and when printing on both sides of the sheet S is completed in a duplex mode. The discharge tray 22 receives the sheet discharged thereon.

In the duplex mode, the discharge roller 73 rotates in the forward direction to convey the sheet S out of the casing 2, and rotates in the reverse direction before the sheet S is discharged out of the casing 2 completely. The sheet S is drawn into the casing 2 and guided by the re-conveying unit 10 along a re-conveying path 100. As shown by a broken line, the sheet S is conveyed again to the image forming unit 4. In other words, the discharge roller 73 switches back the sheet S partially discharged out of the casing 2 toward re-conveying rollers 130 along the re-conveying path 100.

<Structure of Re-Conveying Unit>

The re-conveying unit 100 defines the re-conveying path 100 and conveys, in the duplex mode, the sheet S along the re-conveying path 100 back to the image forming unit 4 while reversing the front and back sides of the sheet S. The re-conveying unit 100 comprises a re-conveying tray 110 and the registration driving rollers 120, and the re-conveying rollers 130.

The sheet S having an image formed thereon by the image forming unit 4 and conveyed by the discharge roller 73 rotating in the reverse direction is guided along the re-conveying path 100. The sheet S is conveyed again, along the re-conveying path 100, to the conveying path 38. The re-conveying path 100 extends downward from the discharge path 71, curves to change its direction frontward and extends, above the feed tray 31, toward a nip position 100A between each re-conveying roller 130 and a corresponding registration conveying roller 120. Further, a guide member 101 defines a U-shaped path which is a portion of the re-conveying path 100. The U-shaped path extends from the nip position 100A between each re-conveying roller 130 and the corresponding registration conveying roller 120 and meets the conveying path 38 at a position upstream of the registration roller pair 122 in a conveying direction of the sheet S.

The guide member 101 is shaped like U open rearward so as to guide the sheet S in a U-turn manner toward a junction 100B between the re-conveying path 100 and the conveying path 38. The guide member 101 defines a downstream portion of the re-conveying path 100 in the conveying direction of the sheet S. After passing along a U-shaped path defined by the guide member 101, the sheet S reaches a nip position 38A between the registration pinch roller 121 and each registration driving roller 120. A path from the nip position 100A to the nip position 38A is set to be shorter than the sheet S. In other words, the sum of a distance, along the re-conveying path, from the nip position 100A to the junction 100B and a distance, along the re-conveying path, from the junction 100B to the nip position 38A is less than a length of the sheet S.

In this embodiment, a length of the sheet S refers to a length, in the conveying direction, of an A4 sheet or a letter-size sheet or the like, but does not refer to a length of a smaller size sheet such as a postcard.

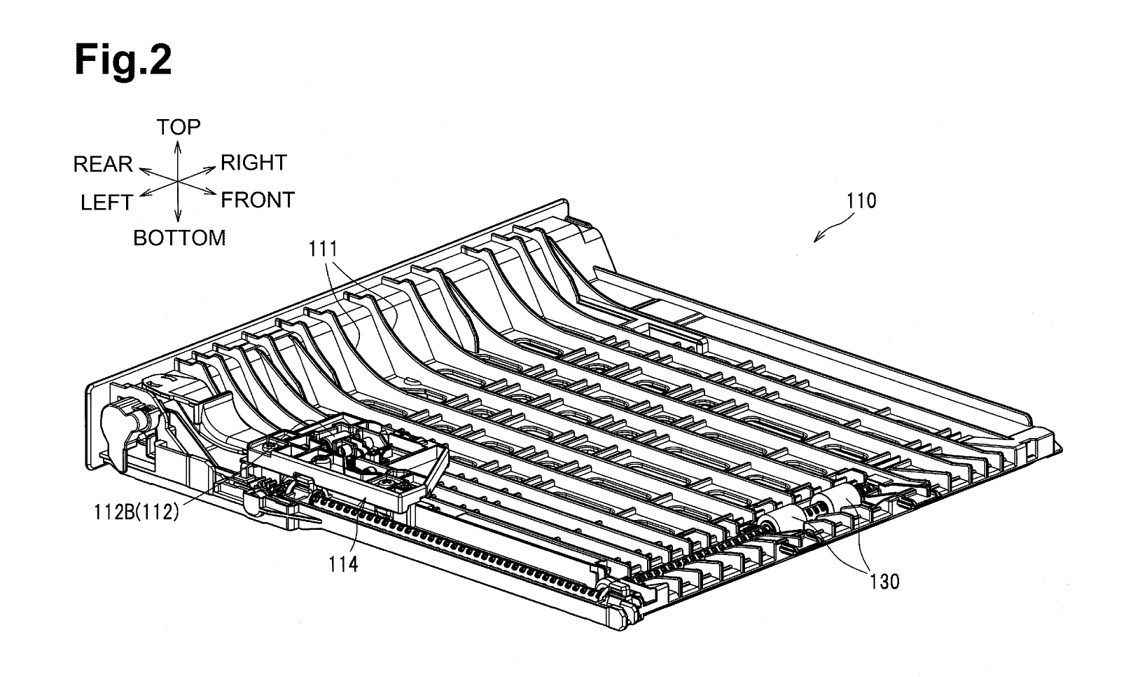

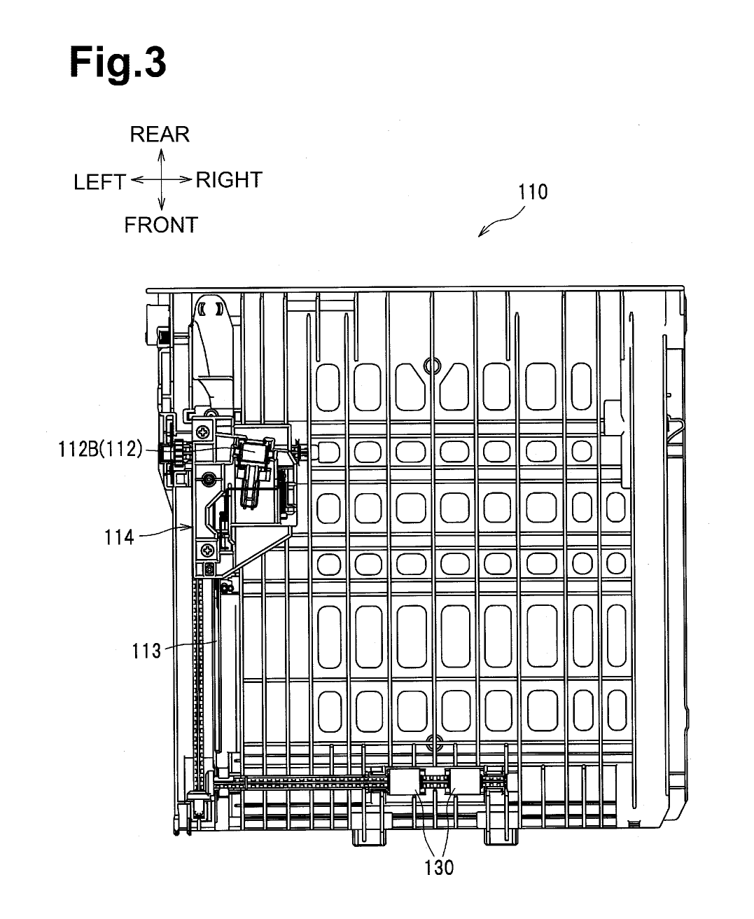

The re-conveying tray 110 is detachably disposed above the feed tray 31 and extends in a front-rear direction along the re-conveying path 100. The re-conveying tray 110, when attached to the casing 2, is positioned between the feed tray 31 and the registration driving roller pair 122 such that the re-conveying rollers 130 are in contact with the registration driving rollers 120, respectively. As shown in FIGS. 2 and 3, the re-conveying tray 110 comprises conveying ribs 111 which extend in the front-rear direction, i.e., the conveying direction of the sheet S, and are arranged in a right-left direction. Each of the conveying ribs 111 comprises a rear portion which is curved so as to guide the sheet S downward and then frontward, and a front portion which extends in the front-rear direction.

A skew correcting mechanism 114 is disposed on the left of and at a central portion, in the front-rear direction, of the re-conveying tray 110. The skew correcting mechanism 114 is disposed rearward of the re-conveying rollers 130, i.e., upstream of the re-conveying rollers 30 in the conveying direction of the sheet S. The skew correcting mechanism 114 comprises an obliquely conveying roller pair 112 for conveying the sheet S obliquely leftward, i.e., toward one side, in a width direction, of the sheet S, and a correcting plate 113 disposed leftward of the obliquely conveying roller pair 112 and extending in the front-rear direction which is the conveying direction of the sheet S.

The obliquely conveying roller pair 112 comprises an obliquely conveying driving roller 112A (shown in FIG. 1) having an axis perpendicular to the conveying direction of the sheet S and an obliquely conveying driven roller 112B disposed obliquely relative to the conveying direction of the sheet S. The obliquely conveying roller pair feeds the sheet S conveyed on the re-conveying tray 110 such that the left edge of the sheet S is abutted against the correcting plate 113. The sheet S is conveyed frontward, i.e., downward in the conveying direction, while its left edge is guided by the correcting plate 113. Consequently, skew of the sheet S is corrected.

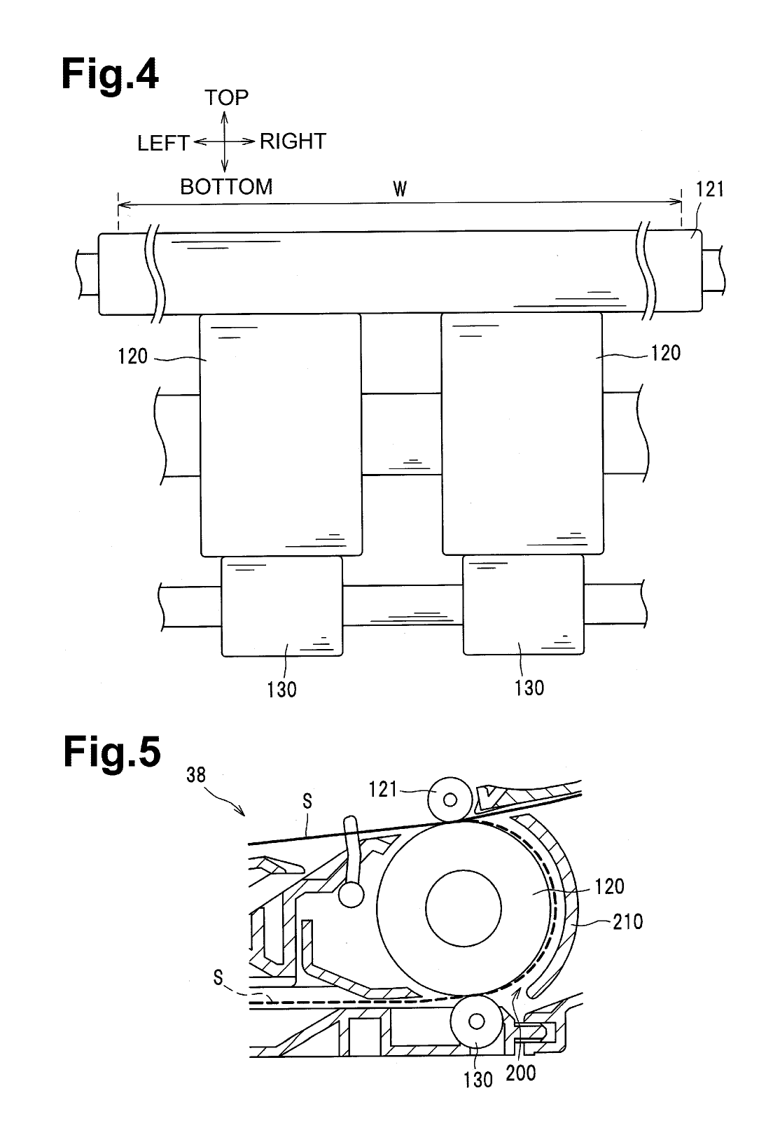

As shown in FIG. 1, the registration driving rollers 120 are disposed above a front end portion of the re-conveying tray 110 and are controlled to stop or rotate so as to correct skew of the sheet S. Specifically, the registration driving rollers The registration driving rollers 120 are configured to convey the sheet S along the conveying path 38 and the re-conveying path 110. The registration pinch roller 121 is disposed above and in contact with the registration driving rollers 120. The registration roller pair, which comprises the registration driving rollers 120 and the registration pinch roller 121, are disposed frontward of the photosensitive drum 51 in the conveying path 38, i.e., upstream of the photosensitive drum 51 in the conveying direction of the sheet S. As shown in FIG. 4, the registration driving rollers 120 comprise two rollers spaced from each other in the right-left direction, i.e., the width direction of the sheet S.

The registration pinch roller 121 is driven and rotated by the registration driving rollers 120. The registration pinch roller 121 has a length in the right-left direction, i.e., the axial direction, greater than a length W, in the width direction, of the sheet S.

As shown in FIG. 1, the re-conveying rollers 130, which are in contact with the registration driving rollers 120, are driven and rotated by the registration driving rollers 120, thereby to convey the sheet S, by way of the junction 38A of the re-conveying path 100 and the conveying path 38, to the nip position 38A between the registration pinch roller 121 and the registration driving rollers 120. Each registration driving roller 120 nips the sheet S in corporation with the registration pinch roller 121 and with the corresponding re-conveying roller 130. This allows the registration driving rollers 120, which is controlled to stop or rotate, to correct skew of the sheet S prior to printing on a front side of the sheet S and prior to printing on a back side of the sheet S. In one embodiment, in the case of printing on a back side of the sheet S, skew of the sheet S may be corrected by both the registration driving rollers 120, which are in contact with the re-conveying rollers 130, and the skew correcting mechanism 114. In another embodiment, in the case of printing on a back side of the sheet S, skew of the sheet S may be corrected by the skew correcting mechanism 114 alone without controlling the registration driving rollers 120.

In the case of printing on a front side of the sheet S, the registration driving rollers 120 are controlled to rotate after a leading edge of the sheet S fed by the feed unit 3 reaches the registration driving rollers 120 in a stopped state. The sheet S thus registered is conveyed further by the registration roller pair 122 for image forming on the front side of the sheet S.

In the case of printing on a back side of the sheet S, the registration driving rollers 120 are controlled to rotate after a leading edge of the sheet S switched back and conveyed along the re-conveying path 100 reaches the registration driving rollers 120 in a stopped state. The sheet S thus registered is conveyed from the re-conveying path 100 toward the conveying path 38, and the sheet S is conveyed further by the registration roller pair 122, without sheet registration, for image forming on the back side of the sheet S.

As shown in FIG. 4, the re-conveying rollers 130 comprise two rollers spaced from each other in the right-left direction. More specifically, the two re-conveying rollers 130 are disposed opposite to the two registration driving rollers, respectively. The length of each re-conveying roller 130 in the right-left direction, i.e., its axial direction, is less than the length of the corresponding registration driving roller 120 in the right-left direction, i.e., its axial direction.

As shown in FIG. 1, each re-conveying roller 30 is disposed opposite to the registration pinch roller 121 relative to the corresponding registration driving roller 120. The diameter of each registration driving roller 120 is greater than the diameter of the registration pinch roller 121 and greater than the diameter of the corresponding re-conveying roller 30. The transfer roller 53 is disposed above the nip position 100A and below the nip position 38A. A distance from a nip position between the transfer roller 53 and the photosensitive drum 51 to the re-conveying path 100 is less than the diameter of the registration driving roller 120.

In the above-described embodiment, the laser printer 1 yields technical advantages as described below. The re-conveying rollers 130 in contact with the registration driving rollers 120 are driven and rotated by the registration driving rollers 120. Thus, there is no need to provide an exclusive driving roller for the re-conveying rollers 130. Three kinds of rollers, i.e., the registration roller pair 122 and the re-conveying roller 130, suffice in total. Accordingly, the number of components disposed along the re-conveying path 100 may be reduced.

The re-conveying path 100 and the conveying path 100B meet at the convergence 100B. The registration pinch roller 121 and each registration driving roller 120 nip the sheet S at the nip position 38A. The sum of the length of the U-shaped path defined by the guide member 101 and the length of the conveying path from the convergence 100B to the nip position 38A is less than the length of the sheet S which has an A4 size or a letter size. Thus, the sheet S is nipped simultaneously at the nip position 38A and at the nip position 100A between each re-conveying roller 130 and the corresponding registration driving roller 120. In this case, the sheet S is conveyed at the same speed at the re-conveying rollers 130 and at the registration pinch roller 121. This may prevent or reduce slackening of the sheet S. Accordingly, the sheet S may be conveyed again smoothly with a reduced resistance to the sheet S.

The re-conveying tray 110, which partially defines the re-conveying path 100, is detachable from the casing 2. Thus, a sheet jammed at the re-conveying rollers 130 or the skew correcting mechanism 114 may be readily removed.

The transfer roller 53 is disposed within the distance between the nip position 100A and the nip position 38A. The transfer roller 53 disposed in a space-saving manner without increasing the height of the laser printer 1.

Although, in the above-described embodiment, the guide member 101 which defines the U-shaped path as a portion of the re-conveying path 100 is spaced frontward away from the circumference of each registration driving roller 120, the guide member 101 may be configured as shown in FIG. 5.

In another embodiment shown in FIG. 5, registration driving rollers 120, Re-conveying rollers 130, and a registration pinch roller 121, which are structured similarly to those in the above-described embodiment, are disposed along a re-conveying path 200. A guide member 210 is disposed such that a curved surface thereof faces a front portion of the circumference of each registration driving roller 120.

The curved surface and the front portion of the circumference of the each registration driving roller 120 define a portion of a re-conveying path 200. The portion of the re-conveying path 200 extends from a nip position between each re-conveying roller 130 and the corresponding registration driving roller 120 to a junction of the re-conveying path 200 and the conveying path 38. In this case, because contact area where the sheet S makes contact with members defining the re-conveying path 200 is reduced, resistance to the sheet S may be reduced as compared with the above-described embodiment shown in FIG. 1.

Although, in the above-described embodiment shown in FIG. 1, the guide member 101 defines a U-shaped path which is shorter than the sheet S and extends to the junction 100B of the conveying path 38 and the re-conveying path 100, the length and shape of the U-shaped path may be changed as long as the conveying path 38 and the re-conveying path 100 meet at a conjunction which is frontward of the registration roller pair 122. For example, the sum of a distance from the nip position 100A in the re-conveying path 100 to the nip position 38A in the conveying path 38 may be greater than the length of the sheet S.

Although, in the above-described embodiment, the skew correcting mechanism 114 is provided along the re-conveying path 100, the skew correcting mechanism 114 may be omitted. Even in this case, skew of the sheet S may be corrected by the registration driving rollers disposed to oppose the re-conveying rollers 120.

Although, in the above-described embodiment, the re-conveying tray 110 is provided to partially define the re-conveying path 100, the re-conveying tray 110 may not be indispensable.

Although, in the above-described embodiment, the re-conveying rollers 130 are disposed in the re-conveying tray 110, the re-conveying rollers 130 may be disposed at a position along the re-conveying path 100 other than the re-conveying tray 110.

Although, in the above-described embodiment, the skew correcting mechanism 114 is disposed in the re-conveying tray 110, the skew correcting mechanism 114 may be disposed at a position along the re-conveying path 100 other than the re-conveying tray 110.

Although, in the above-described embodiment, the length of the registration pinch roller 121 is greater than the width of the sheet S, the length of the registration pinch roller 121 may be less than the width of the sheet S.

Although, in the above-described embodiment, a single registration pinch roller 121 is provided with respect to its axial direction, a plurality of registration pinch rollers may be provided.

Although, in the above-described embodiment, two registration driving rollers 120 are provided with respect to its axial direction, one registration driving roller or three or more registration driving rollers may be provided.

Although, in the above-described embodiment, two re-conveying rollers 130 are provided with respect to its axial direction, one re-conveying roller or three or more re-conveying rollers may be provided.

Although, in the above-described embodiment, the length of each re-conveying roller 130 in its axial direction is less than the length of the corresponding registration driving roller 120, the length of each re-conveying roller in its axial direction may be greater than the length of the corresponding registration driving roller.

Although, in the above-described embodiment, the monochrome laser printer 1 is described as an example of an image forming apparatus, the invention may be embodied as other image forming apparatuses such as a color laser printer and a multifunction apparatus with an image reading device.

While the invention has been described in connection with embodiments of the invention, it will be understood by those skilled in the art that variations and modifications of the embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being defined by the following claims.

What is claimed is:

1. An image forming apparatus comprising:
a feed tray configured to hold a sheet thereon;
an image forming unit comprising a photosensitive member and configured to form an image on the sheet;
a registration mechanism comprising a registration roller pair and configured such that, after a leading edge of the sheet fed from the feed tray reaches the registration roller pair, the registration roller pair rotates to convey the sheet toward the photosensitive member along a conveying path in a conveying direction;
a switchback mechanism disposed downstream of the photosensitive member in the conveying direction and configured to switch back, along a re-conveying path, the sheet having the image formed thereon by the image forming unit; and
a re-conveying roller configured to convey the sheet switched back by the switchback mechanism toward the registration roller pair via a junction where the re-conveying path meets the conveying path,
wherein the registration roller pair comprises a registration driving roller, and a registration pinch roller configured to be driven by the registration driving roller, and
wherein the re-conveying roller is in contact with the registration driving roller and configured to be driven by the registration driving roller.

2. The image forming apparatus according to claim 1, wherein a sum of a distance, along the re-conveying path, from a first nip position between the re-conveying roller and the registration driving roller to the junction and a distance, along the conveying path, from the junction to a second nip position between the registration pinch roller and the registration driving roller is less than a length in the conveying direction of the sheet which has a letter size.

3. The image forming apparatus according to claim 1, further comprising a skew correcting mechanism disposed along the re-conveying path at a position upstream of the re-conveying roller in the conveying direction, and configured to correct skew of the sheet switched back by the switchback mechanism.

4. The image forming apparatus according to claim 3, wherein the skew correcting mechanism comprises an obliquely conveying roller configured to convey the sheet obliquely relative to the conveying direction, and a correcting plate extending in the conveying direction and configured to guide an edge of one of opposite sides in a width direction of the sheet, the width direction being perpendicular to the conveying direction.

5. The image forming apparatus according to claim 1, further comprising:
a casing which houses therein the image forming unit and the registration roller pair; and
a re-conveying tray detachably attached to the casing to define a portion of the re-conveying path, the re-conveying tray comprising the re-conveying roller.

6. The image forming apparatus according to claim 1,
wherein a length of the registration pinch roller in an axial direction thereof is greater than a length of the sheet in a width direction thereof perpendicular to the conveying direction,
wherein a plurality of the registration driving rollers are spaced from each other in the width direction of the sheet, and a plurality of the re-conveying rollers are disposed opposite to the plurality of the registration driving rollers, respectively, and
wherein a length of each of the re-conveying rollers in an axial direction thereof is less than a length of a corresponding one of the registration driving rollers in an axial direction thereof.

7. The image forming apparatus according to claim 1, further comprising a guide member having a curved surface, wherein the curved surface and a circumference of the registration driving roller define a portion of the re-conveying path, the portion extending from a nip position between the re-conveying roller and the registration driving roller to the junction of the re-conveying path and the conveying path.

8. The image forming apparatus according to claim 1, wherein the registration mechanism is configured such that, after a leading edge of the sheet switched back by the switchback mechanism reaches a nip position between the re-conveying roller and the registration driving roller, the registration driving roller rotates to drive the re-conveying roller.

9. The image forming apparatus according to claim 1, wherein the re-conveying roller is disposed opposite to the registration pinch roller relative to the registration driving roller.

10. The image forming apparatus according to claim 1, wherein the image forming unit further comprises a transfer roller configured to transfer the image onto the sheet and disposed opposite to the photosensitive member at a position above a first nip position between the re-conveying roller and the registration driving roller and below a second nip position between the registration pinch roller and the registration driving roller.

11. The image forming apparatus according to claim 1, wherein the image forming unit further comprises a transfer roller configured to transfer the image onto the sheet and disposed opposite to the photosensitive member, and a distance from a nip position between the photosensitive member and the transfer roller to the re-conveying path is less than a diameter of the registration driving roller.

12. The image forming apparatus according to claim 1, wherein a diameter of the registration driving roller is greater than a diameter of the registration pinch roller and greater than a diameter of the re-conveying roller.

13. The image forming apparatus according to claim 5, wherein the re-conveying tray is detachably attached to the casing at a position between the feed tray and the registration roller pair.
